(19) United States
(12) Patent Application Publication
(10) Pub. No.: US 2025/0249403 A1
(43) Pub. Date: Aug. 7, 2025

(54) SYSTEMS AND METHODS FOR WASTE GAS TREATMENT

(71) Applicants: Danmarks Tekniske Universitet, Kongens Lyngby (DK); KØBENHAVNS UNIVERSITET, Copenhagen K (DK)

(72) Inventors: Seyed Soheil MANSOURI, Kongens Lyngby (DK); Martin Peter ANDERSSON, Kongens Lyngby (DK); Matthew Stanley JOHNSON, Copenhagen K (DK); Peter Riis HANSEN, Copenhagen K (DK); Christian BEENFELDT, Kalundborg (DK)

(21) Appl. No.: 18/856,071

(22) PCT Filed: Apr. 13, 2023
(86) PCT No.: PCT/EP2023/059641

§ 371 Date: Oct. 11, 2024

(30) Foreign Application Priority Data
Apr. 13, 2022 (EP) 22168123.2

(51) Int. Cl. B01D 53/75; B01D 53/14; B01D 53/56; B01D 53/70; B01D 53/78

(52) U.S. Cl. CPC B01D 53/75; B01D 53/1493; B01D 53/56; B01D 53/70; B01D 53/78; B01D 2251/404; B01D 2252/10; B01D 2257/2066; B01D 2257/40; B01D 2259/124; B01D 2259/4533; B01D 2259/804

(57) ABSTRACT

A system for waste gas treatment is provided. The system for waste gas treatment comprises a photochemical reactor comprising an ultraviolet source. The photochemical reactor is configured to receive a waste gas and to break down, by using the ultraviolet source, the waste gas into one or more primary gaseous by-products. The system for waste gas treatment comprises an absorption reactor. The absorption reactor is connected in series with the photochemical reactor. The absorption reactor is configured to collect and/or convert the one or more primary gaseous by-products into one or more secondary by-products by the use of a liquid containing calcium ions.

The present disclosure pertains to the field of gas treatment. The present disclosure relates, in particular, to a system and a method for waste gas treatment, such as anesthetic waste gas and/or refrigerant waste gas, such as by applying destructive waste gas treatment.

### BACKGROUND

In general, waste gases, such as anesthetic gases, refrigerant gases, and/or halogenated gases, as well as other types of gases, have been seen as potent greenhouse gasses which have higher impact on the environment than carbon dioxide, CO₂, on a kg per kg basis. Furthermore, long-term exposure to the waste gases, such as exposure of operating room personnel to anesthetic gas, could potentially be hazardous to persons and can lead to genotoxic effects.

In fact, on a global scale, there is a markedly increased awareness of the deleterious climate effects of greenhouse gases, and mitigation of these gases has high priority in national and international climate policies. Denmark is at the forefront of this movement and in the Danish regions, CO₂ emissions of hospital facilities is an evolving focus area, with particular attention being given to the contribution of waste anesthetic gas (WAG). CO₂ emission costs can be expected to rise steadily in the next 10 years predominantly in Europe, USA and China. In Denmark, the Council on Climate Change (Klimarådet) has proposed a green tax of DKK 1500 pr. tons CO₂ by 2030. This figure can be contrasted with the resent estimate by the New York State Department of Environmental Conservation puts the worldwide value of CO₂ reduction at $125/DKK 780 per ton of CO₂ and $44,727 per ton N₂O.

Two classes of technologies have generally been considered in order to remove WAGs:
A) non-destructive technologies, including using scavenging, capturing, ventilation, and recovering methods; and
B) destructive technologies that mostly include advanced oxidation processes. Various non-destructive technologies, including using scavenging, capturing, ventilation, and recovering methods, have been used for treatment of waste gases. In some scenarios, the waste gases from anesthetic machines may be vented directly to the outdoor atmosphere, and the non-destructive systems may not provide complete waste gas destruction. With the non-destructive approach, waste anesthetic gases (WAGs) must be recovered and might be recycled and sold as acceptable medical grade agents, however only if brought to meet regulatory standards which requires high energy and cost expenditures for, e.g., distillation and control processes to reach the required purity. Furthermore, environmental regulations for handling of anesthetic gases are very restrictive and, retrieved WAGs must be removed from the supply chain in a safe way, as well as handled, stored, transported to recovery, and transported back to re-use. Removal and possible recovery have proven to be a new business area and many companies today provide such systems and methods for scavenging and recovering from a surgery room for these potentially hazardous and ozone-atmosphere-layer destroying compounds. However, these recovery methods all as mentioned seem to require regulatory approval for medical reuse of the recovered products and are linked to increased CO₂ emissions during their retrieval, storage, handling, transport, and re-application into anesthetic use. This hinders these recovery methods to be truly CO₂-efficent and an effective source of re-usable anesthetic gas.

Therefore, destructive methods have been found promising and robust options to eliminate other toxic agents and pollutants and do not have the above-mentioned limitations of non-destructive methods. Advanced oxidation processes are as mentioned destructive methods that today are primarily used for air pollution control. These methods provide for irradiating chemicals to produce reactive agents, which have the potential to convert the pollutants to benign products like water and carbon dioxide (CO₂).

A few previous attempts to destructively deal with the WAGs are found in JP2005262180A and the article “New Method of Destroying Waste Anesthetic Gases Using Gas-Phase Photochemistry” (2019) by Rauchenwald, et. al (International Anesthesia Research Society, July 2020, Volume 131, Number 1).

JP2005262180A addresses a problem of how to provide a higher efficiency of nitrous oxide removal from WAGs such as nitrous oxide, sevoflurane, and isoflurane. It provides a method and system for anesthetic gas removal by destructive methods by using a wet treatment at room temperature of the anesthetic gas. As shown in FIG. 1 thereof, the system comprises a reactor comprising a plurality of solid calcium containing zinc oxide sintered bodies ref. no. 14 acting as a photocatalyst while irradiated with UV light from mercury lamp ref. no. 22 with UV light of wavelength 253.7 nm and being showered with alkaline water from shower ref. no. 28. However, FIGS. 4-5 disclose that the effectiveness of the removal of the nitrous oxide is relatively low, namely 1/10. Therefore, the document describes, as solution to this, a requirement to provide a series of redundant reaction chambers needed for an iterative processing of in particular the nitrous oxide gas in order to achieve the necessary higher effective removal. Thus, a main drawback is the space required for providing this multi-reactor system, and thus they suggest placing the system away from the surgery room, such as either on a rooftop or in a cellar. The suggested system is therefore not particularly space saving nor effective in decomposing the nitrous oxide.

The article “New Method of Destroying Waste Anesthetic Gases Using Gas-Phase Photochemistry” (2019) by Rauchenwald, et al., addresses a problem of how to decompose WAGs in an effective way. The article discloses a reactor system, see FIG. 1A for breaking down specific anesthetic gases comprising halogenated compounds and nitrous oxide passed along in a WAG flow past a UV lamp of an elongated design using ultraviolet light at a particular wavelength of 185 nm. According to the article, this wavelength could be used both as a) a generator of ozone which chemically react as gas phase radical to break down both nitrous oxide and the halogenated compounds; and b) as direct photolysis effective to break down in particular the nitrous oxide gas. However, the results of testing the reactor from FIG. 1 proved more effective in breaking down the halogenated compounds than breaking down the nitrous oxide. According to the results in Table 1 the effectiveness to remove nitrous oxide lay around 3.9% and 11.5% depending on flow rate and inlet N₂O concentrations. Also, increasing the amount of ozone did not result in an increased effectiveness in removing nitrous oxide. Thus, Rauchenwald et al. suggest, in the key points, to modify the design of the reactor design in order to more effectively remove the nitrous oxide part of the WAGs. However, no solution to this defined technical problem is provided.

JPH04293517A relates to a method for treating ozone layer destroying substances by subjecting them to ultraviolet irradiation treatment and chemical decomposition treatment in a liquid phase.

### SUMMARY

Accordingly, there is a need for a system and a method which may mitigate, alleviate or address the shortcomings existing with the previous processes and systems and may provide improved treatment such as improved effectiveness in removing nitrous oxide of waste gas, such as waste anesthetic gas and/or refrigerant gas and/or provide destructive treatment of such waste gas.

A method is disclosed for destruction of waste anesthetic and/or refrigerant gas. The method comprises introducing waste anesthetic and/or refrigerant gas in a photochemical reactor and breaking down the waste gas in the photochemical reactor into one or more primary gaseous by-products through irradiation with ultraviolet light and a gas-phase reaction with reactive radicals produced by irradiation with ultraviolet light. The thereby produced the primary gaseous by-products are conveyed into an absorption reactor separate from the photochemical reactor. Herein, the one or more primary gaseous by-products are converted into one or more secondary by-products in the absorption reactor through reaction with a liquid containing calcium ions.

Further, a system for waste gas treatment is provided, the system comprising a photochemical reactor comprising an ultraviolet source, wherein the photochemical reactor comprises inputs to receive a waste anesthetic and/or refrigerant gas and one or more gaseous additives and is configured to irradiate received gasses in the photochemical reactor with ultraviolet light to break down the waste anesthetic and/or refrigerant gas into one or more primary gaseous by-products in gas-phase reactions; and an absorption reactor being separate from and connected in series with the photochemical reactor to receive the one or more primary gaseous by-products, the absorption reactor being configured to hold a liquid containing calcium ions and to mix the received one or more primary gaseous by-products with the liquid containing calcium ions to convert the one or more primary gaseous by-products into one or more secondary by-products.

Advantageously, the present disclosure allows for the performance of an effective treatment of a variety of waste gases, and the byproducts of a breakdown of waste gases, for release of non-harmful final byproducts which does not require high carbon use recovery. The disclosed systems and methods can allow for a complete, or almost complete removal of, and/or breakdown of, hazardous waste gases, such as into environmentally friendly components.

In particular, the present disclosure allows for the destruction of nitrous oxide, especially through the utilization of a secondary reactor. For example, it was unexpected that the same solution containing calcium used for scrubbing hydrogen fluoride (HF) also showed itself to be effective in removing nitrous oxide gas. In an advantageous embodiment of the system and method the flow rates of the waste gas being treated are aligned to provide the highest percentage of nitrous oxide and its break down by-products after the first reactor being broken down in the second reactor, thus eliminating harmful nitrous oxide by-products along with any other harmful by-products.

Moreover, the systems and methods may fully utilize existing infrastructure where the system is intended to be used. For example, because of its mobility and relatively small size in physical space, the systems and methods can be easily integrated in, e.g., a hospital or other industrial environment. Additionally, due to the closed-ness of the systems, no waste products are released into the environment, and there are no additional treatment or transportation requirements. With quite moderate energy demands and consumption the system can be used for a variety of applications. This is an improvement over technologies which provide scavenging/capture solutions for potential reuse/recycle of waste gas, either without an initial destruction of waste gas or not, which is heavily regulated and requires high energy and cost demands.

For example, in accord with the Danish national policy aimed at climate change mitigation, elimination of waste gases has a high societal priority. The present disclosure can advantageously convert waste gases, such as waste anesthetic gases, into eco-friendly products not needing recover, and therefore will help in the reduction of greenhouse gas emissions.

Additionally, as the present disclosure may be able to safely destroy waste gas, such as anesthetic gases and/or refrigerant gases, at the site rather than vented into the atmosphere, it may be possible for anesthetic machines fitted with and/or connected to a system disclosed herein to operate without the need for exhaust connection to the hospital venting system, which in turn can simplify the construction of surgical operating rooms. The disclosure can safely destroy waste gas at the site and can enable hospital operating rooms to be built without expensive and inflexible exhaust connections necessitated by anesthesia machines. This reduces the construction costs of future hospitals, and it will increase the flexible usability of existing hospital space. For example, as the present disclosure can advantageously safely destroy gasses at the site, this may enable facilities to be built without expensive and inflexible exhaust connections necessitated by anesthesia machines. The present disclosure can be advantageous for use in facilities, such as hospitals, dental clinics, veterinary clinics, and other producers of waste gas. In fact, embodiments of the disclosure can be mass-produced and placed on the roof of newly built and renovated hospitals. The disclosed systems can be highly energy-efficient and require only a small amount of electricity to run on. The total life cycle of CO₂ footprint of the system will only be a negligible fraction of the CO₂ benefit to hospitals obtained from the gas destruction. The disclosed systems and methods can be in operation rooms, be used for on-site cleaning of already stored gases, be used as add-ons for existing anesthesia machines, and also be a built-in waste gas solution.

Further, the disclosure can utilize reactive oxidant, O(1D) a reactive radical that may be produced by irradiating gasses in the photochemical reactor with ultraviolet light, which is able to react with halocarbon bonds like C—F-bonds. In particular, the present disclosure may advantageously be configured to break down carbon-halogen bonds, which can be difficult. Further, the present disclosure may be configured for removing fluoride, such as organo-halogens containing fluoride, or other fluorinated compounds.

Additionally, the disclosure can advantageously synergistically use two type of reactors—a gas phase based photochemical reactor and a liquid phase-based absorption reactor—and, by combining the two reactor stages, an effect is achieved that cannot be achieved by either stage acting alone. For example, the disclosure is advantageously capable of simple and effective destruction of waste gas. However, as discussed above, harmful byproducts may be created via the destruction process which would require recovery and/or transport. Unknown to the art, the disclosure can allow for conversion and retrieval of any possible harmful by-products of the destruction process into harmless and potentially useful species usable on site or to be retrieved for other industrial use. Other available destructive technologies have ignored this critical step, and in fact do not appear to realize that this is a necessary step. For example, both JP2005262180A and Rauchenwald et al. require further recovery processing.

There is, unsurprisingly, no existing such system in this field which combined a destructive approach with scrubbing of the waste gas-containing stream without harmful by-product formation, as the art has not realized the importance of such a two-step approach.

The following is a discussion of the advantageous of the disclosed systems and methods compared to current technology:
Direct destruction: The commercialized types do not remove waste gases as their function and are only based on separation of the waste gases. The disclosed systems and methods can have a complete destruction process that counters the limitations of the non-destructive methods and addresses the still rather ineffective previously suggested destructive methods and systems.
Green waste disposal: The disclosed systems and methods can include a second scrubbing phase in the absorption reactor, wherein the reaction products of destruction (such as one or more primary gaseous byproducts) are significantly converted into environmentally friendly substances like CaF₂, water, and CO₂.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example system for waste gas treatment for according to this disclosure,

FIG. 2 is a flow-chart illustrating an example method, performed by an exemplary system for waste gas treatment according to this disclosure,

FIG. 3 shows an example of sevoflurane removal from a simulated exhaust from an anesthetic delivery machine after a photochemical reactor, and

FIG. 4 shows FTIR absorption measurements in gas phase (similar to the FIG. 3 above) at a higher gas flow rate (4.74 In/min).

FIGS. 5 and 6 show FTIR absorption measurements of the common exhaust gas from 32 surgery theaters in a hospital. The measurements show the recorded absorption of sevoflurane (SEVO, FIGS. 5) and N₂O(FIG. 6) as well as fitted reference spectra.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described. Several different exemplary methods and systems are described. Some features, though only described in relation to a particular system or method, can be used in combination with another system or method as well although not explicitly described in relation thereto. This is to avoid the extensive description of all exemplary features in relation to all exemplary methods and systems.

Disclosed herein is a system and/or method which can combine destruction, e.g., a photochemical destruction, such as a photocatalytic destruction, and absorption, such as capture, processes using two reactors in series, such as a first reactor, e.g., a photochemical reactor, and a second reactor, e.g., an absorption reactor. Further, the disclosed systems can include a control unit for monitoring and controlling the system and the disclosed methods can include controlling the destruction of waste anesthetic and/or refrigerant gas by monitoring and controlling the system or parts thereof. Since the disclosed method may be viewed as a method of operating the disclosed system to destruct waste anesthetic and/or refrigerant gas, exemplary embodiments described in relation to the system are also applicable to the method and vice versa.

The disclosed systems and methods can use a synergistic two-reactor system for processing of waste gas.

The first reactor is a photochemical, such as photo-oxidation, reactor, comprising a source of ultraviolet light, such as UV-C light, irradiating gas inside the reactor. The waste anesthetic and/or refrigerant gas is introduced into the photochemical reactor and broken down into one or more primary gaseous by-products through irradiation with the ultraviolet light as well as through gas-phase reactions with reactive radicals produced by irradiation with ultraviolet light. In an exemplary embodiment, the reactive radicals are produced by irradiating gasses in the photochemical reactor with ultraviolet light, and the waste anesthetic and/or refrigerant gas in the photochemical reactor is broken down into one or more primary gaseous by-products through a gas-phase reaction with the produced reactive radicals.

In one or more exemplary embodiments, the photochemical reactor can employ the UV light to produce, using one or more additives such as H₂O, NOₓ, NH₃, O₃ and O₂, highly reactive radicals including O(³P), O(¹D), HO₂, and OH. The radicals can react with waste gases and convert those into primary products such as water, CO₂, and one or more primary gaseous byproducts, e.g., halogenated by-products. For example, excited oxygen atoms can react with fluorides, chlorides, and/or bromides. A combination of several photochemical reactors connected in series with an optional addition of the above-mentioned additives to each reactor can be used in order to increase efficiency of the treatment process if necessarily. Hence, in some exemplary embodiments, the photochemical reactor comprises two or more photochemical reactor chambers connected in series, each photochemical reactor chamber comprising an ultraviolet light source. In this embodiment, the two or more photochemical reactor chambers comprises a fluid connection to convey the waste anesthetic and/or refrigerant gas and produced primary gaseous by-products from a first photochemical reactor chamber in the series to a last photochemical reactor chamber in the series via any intermediate photochemical reactor chamber in the series. In this embodiment, the method comprises conveying the waste anesthetic and/or refrigerant gas and produced primary gaseous by-products from a first photochemical reactor chamber in the series to a last photochemical reactor chamber in the series, before it is conveyed to the absorption reactor.

In one or more exemplary embodiments, part of the gas from the last photochemical reactor chamber can be re-circulated, i.e. can be provided as an input for the first reactor chamber. In this embodiment, the two or more photochemical reactor chambers comprises means to re-circulate at least part of the waste anesthetic and/or refrigerant gas and produced primary gaseous by-products from one photochemical reactor chamber in the series to a previous photochemical reactor chamber in the series. In this embodiment, the method comprises re-circulating at least part of the waste anesthetic and/or refrigerant gas and produced primary gaseous by-products from one photochemical reactor chamber in the series to a previous photochemical reactor chamber in the series.

The means to re-circulate may comprise one or more of tubes, pipes, hoses, conduits, ducts, funnels to provide a gaseous communication between the one chamber and the previous chamber in the series. The means to re-circulate may further comprise a pump to generate flow or pressure to drive the movement of gas through the gaseous communication. The means to re-circulate may further comprise a pump, valve, a nozzle, or a piston, to regulate movement of gas through the gaseous communication.

The improvements the present disclosure provides can be one or more of: 1) additives (e.g. H2O, NOx, NH3, O2) to improve reaction chains, 2) control of flow and concentration of additives, 3) selection of optimal light wavelengths, 4) control of light intensity, 5) addition of swirling mechanism to increase residence time and improve reaction mixture, and 6) control of the flow through the system, including possible recirculation through the photochemical reactor, based on the performance of the integral system measured and monitored by adequate sensors.

The second reactor is an absorption reactor. In the absorption reactor, the one or more primary gaseous by-products of the photochemical reactor can be stripped from the airstream and may be converted to one or more final products, such as one or more secondary by-products which may comprise harmless solid and environmentally friendly gases. The control unit can be implemented to monitor the absence of harmful gases from the system's exhaust and ensure the optimal performance and safety of the process. The control unit can be implemented to maintain proper pH levels to ensure proper precipitation, such as through the addition of calcium hydroxide (Ca(OH)₂). The disclosed system and method can integrate the above components allowing easy and reliable use in e.g. clinical practice or other industrial environment.

In one or more exemplary embodiments, the system can be an integrated part of an anesthesia machine. In one or more exemplary embodiments, the system can be a standalone unit that functions independently. In one or more exemplary embodiments, the system can be integrated into an institutional or industrial core facility. If used with an anesthesia machine, the disclosed system can include a connection between the output of the later and the input of the vacuum system in an operating room.

If used for anesthetic waste gas, the system may be known as a waste anesthetic gas elimination reactor (WAGER) that can convert waste anesthetic gases into eco-friendly products. The system can be configured to reduce Danish greenhouse gas emissions by the equivalent of 35000 tons CO₂ per year. At the European level, the system can provide a reduction equivalent to 6600000 tons CO₂ per year.

In exemplary embodiments, the waste anesthetic and/or refrigerant gas is a waste anesthetic gas comprising one or more of: nitrous oxide, isoflurane, desflurane and sevoflurane. Here, the disclosure provides an integrated waste anesthetic (or anaesthetic, both of which can be used interchangeably herein) gas elimination reactor system and a method utilising such system. The system comprises a photocatalytic reactor, an absorption reactor, and optionally a control unit configured to regulate the photocatalytic reactor and absorption reactor operation parameters. The photocatalytic reactor includes an ultraviolet lamp, for example that operates at a wavelength in the range of 185 nm-254 nm. The absorption reactor includes a fluoride removal solution, such as a liquid solution using calcium chloride. In the reactor system of the disclosure, the photocatalytic reactor and the absorption reactor are connected in series. In the reactor system of the disclosure, the photocatalytic reactor can be a two- or more steps reactors connected in series. If necessarily the number or the volume of absorption reactors can be increased accordingly. In the reactor system of the disclosure, the photocatalytic reactor can be first, and one or more of absorption reactors can be connected to the photocatalytic reactor. Each of the plurality of absorption reactors may have different aspects for breaking down different one or more primary gaseous byproducts.

More specifically, when an anesthetic gas or a gas mixture comprising an anesthetic gas enters the photocatalytic reactor, the photocatalytic reactor breaks down the anesthetic gas into one or more gaseous by-products, typically including fluoride compounds. The breaking down occurs by irradiation of the anesthetic gas with UV light and/or by reaction of the anesthetic gas component with a reactive radical produced by irradiation the anesthetic gas, ambient gasses therein, and/or an additive with the ultraviolet light. As an example, the breaking down of the anesthetic gas may be through a gaseous reaction with ozone obtained by irradiation of oxygen with the ultraviolet light of oxygen which is either part of the waste anesthetic gas or added as an additive. The one or more gaseous by-products may then be bubbled through a fluoride removal solution in the absorption reactor to remove traces of fluoride compounds, such as harmful HF. Other or additional processes or systems than a bubble column utilizing the fluoride removal solutions suitable for removing HF and/or nitrous oxide can be envisaged combining a liquid or steam fluoride removal solution and a gas by-product, such as one or more of a shower system or other existing systems suitable for providing a liquid/gas interaction. During the fluoride compounds removal procedure, the control system, if used, can regulate the pH of the solution to a range of from about 6 to about 8, amongst other controls, in the absorption reactor. The control system, if used, can also regulate the photocatalytic reactor, as discussed below.

Anesthetic gas is one contributor to greenhouse gases. Anesthesia is used to induce an anesthetized state where patients are unconscious and can undergo surgery or other invasive procedures. Anesthetic gasses can be inhaled volatile gases, such as nitrous oxide (N₂O), isoflurane (C₃H₂ClF₅O), desflurane (C₃H₂F₆O), halothane (C₂HBrClF₃), enflurane (C₃H₂ClF₅O) and sevoflurane (C₄H₂F₇O). Hence, in the context of the present invention, nitrous oxide (N₂O) is considered an anesthetic gas. These gases are only minimally absorbed in the human body during inhalation anesthesia. Accordingly, around 95% of the gas used for anesthesia is exhaled and subsequently released directly to the atmosphere. Although inhalation anesthetics are indispensable in modern healthcare, these gases are potent greenhouse gasses with up to 2000 times the climate impact of CO₂ on a kg per kg basis. Similarly, refrigerant gases released directly into the atmosphere have one of the biggest negative impacts on the greenhouse effect and, therefore, have a major impact on global warming. Other waste gases can similarly have negative environmental consequences.

A method and a system for waste gas treatment is disclosed, where the method may be embodied as the operation of the system. The system comprises a photochemical reactor. The photochemical reactor comprises an ultraviolet source. In one or more exemplary embodiments, the photochemical reactor is configured to receive a waste gas. In one or more exemplary embodiments, the photochemical reactor is configured to break down, by using the ultraviolet source, the waste gas into one or more primary gaseous by-products. The system comprises an absorption reactor. In one or more exemplary embodiments, the absorption reactor is connected in series with the photochemical reactor. In one or more exemplary embodiments, the absorption reactor is configured to collect and/or convert the one or more primary gaseous by-products into one or more secondary by-products. In one or more exemplary embodiments, the absorption reactor is configured to collect and/or convert the one or more primary gaseous by-products into one or more secondary by-products using a liquid containing water and calcium ions.

The disclosed system, which is a combination of a photochemical reactor and an absorption reactor, can form an integrated system of two continuous reactors. The system may optionally include a control unit for monitoring and/or controlling operation of the system. Optionally, the flows from the patient to photochemical reactor can be accumulated in a buffer tank prior to entering the absorption reactor, which can reduce disturbances and flowrate fluctuations. Further, the present disclosure advantageously allows for a controllable treatment of waste gases. For example, using a control unit to control the inflow of waste gases and conditions for treatment of waste gases and/or one or more by-products, allowing for improved breaking down of the waste gases.

The absorption reactor in the disclosure can advantageously remove harmful by-products from prior waste gas destruction in the photo-oxidation reactor and can remove one or more of nitrogenous-, chloride- and fluoride-containing by-products.

In one or more exemplary embodiments, the photochemical reactor may be a hollow structure, such as a hollow container, a hollow cylinder, and/or a tube. In one or more exemplary embodiments, the photochemical reactor may be configured to receive a waste gas. In one or more exemplary embodiments, the photochemical reactor may be configured to receive one or more waste gases. A diameter of the photochemical reactor can be determined based on the absorption of the light by atmospheric gases, and a length of the photochemical reactor can be based on the flow through the system.

The photochemical reactor is configured to receive a waste gas. In one or more exemplary embodiments, the waste gas is a waste gas comprising one or more of: nitrous oxide, an organohalogen gas, a halogenated anesthetic gas, and a gas containing organohalogen vapors from one or more of: solvents, pesticides, refrigerants, fire resistant oils, ingredients of elastomers and drugs, and waste gas from production and use of plastics, plasticizers, adhesives, and sealants. The waste gas can be organo-halogen compounds including chloroflourocarbons (CFCs).

The waste gas can, for example, comprise anesthetic gas and/or refrigerant gas, such as used or re-used gasses. The waste gas to be broken down can also optionally be waste gases from the production of electric insulators, foam manufacturing, and electronic components. The waste gas may include a halogen and/or, and/or it may include N₂O. The waste gas may include NOx. The waste gas can be fluorinated greenhouse gasses such as CFCs. Waste gases can include one or more of: aerosol propellants, foam and insulation blowing agents, and fire extinguishing agents. Waste gas can be halogenated organics and/or halogenated anesthetic gases. Waste gases include halogenated organics. The waste gas may be semi-fluid. The waste gas may not be semi-fluid. Waste gas can include hydrochlorofluorcarbons, for example that are used as substitutes for chlorofluorocarbons as solvents/cleaning agents, refrigerants, foam-blowing agents, and air conditioning fluids.

Refrigerants, a type of waste gas, can include one or more of: an organohalogen gas, R131a, R410a, 1,1,1,2 tetrafluoroethane (also known as norflurane (INN)), R-134a, Freon 134a, Forane 134a, Genetron 134a, Green Gas, Florasol 134a, Suva 134a, and HFC-134a, one or more of which can have a hundred-year global warming potential of 1430. These types of gases can be vulnerable to a number of oxidizing radicals produced in the photochemical system including O(1D) and the OH radical.

In one or more examples, organohalogen gas may comprise an organofluorine and/or organochlorine gas.

In one or more exemplary embodiments, the waste gas to be processed includes a waste anesthetic gas comprising one or more of: nitrous oxide, isoflurane, desflurane and sevoflurane.

In one or more exemplary embodiments, the waste gas to be processed includes an organohalogen gas.

In one or more exemplary embodiments, the waste gas to be processed includes an ambient gas such as one or more of atmospheric air, N₂, O₂ and H₂O_{(g)}.

In one or more exemplary embodiments, the photochemical reactor may be configured to receive a waste gas, such as through an inlet.

Additionally, while the term waste gas is being used, it will be understood that the system may be configured to receive gas generally, or molecules generally, and that waste gas broadly covers all input into the system.

In one or more exemplary embodiments, the photochemical reactor is configured to receive one or more additives. In one or more exemplary embodiments, the one or more additives may be used to break down the waste gas into the one or more primary gaseous by-products. In one or more exemplary embodiments, the one or more additives may be used as a catalyst to break down the waste gas into one or more primary gaseous by-products. In one or more exemplary embodiments, the one or more additives may be a radical quencher. In one or more exemplary embodiments, the one or more additives may optimize the reaction stoichiometry.

In one or more exemplary embodiments, the one or more additives comprise one or more of: H₂O, NOₓ, NH₃, O₃ and O₂. In one or more exemplary embodiments, NOx may be seen as nitric oxide (NO) and/or nitrogen dioxide (NO₂). Normal atmospheric air, which will always contain amounts of H₂O and O₂, will typically be present as an ambient gas in the photochemical reactor per se.

In one or more exemplary embodiments, water vapor may be an additive.

In one or more exemplary embodiments, the one or more additives may be used to improve the breaking down the waste gas into the one or more primary gaseous by-products.

In one or more exemplary embodiments, the photochemical reactor may be configured to receive an additive, such as through an inlet. The additive may be stored in the photochemical reactor.

In one or more exemplary embodiments, the photochemical reactor may comprise an ultraviolet (UV) light source used to irradiate gas inside the photochemical reactor. The UV light source may be one or more of a mercury vapor fluorescent light bulb, incandescent light bulb, and an excimer light bulb. As used herein, a light bulb can be, for example, a part of a lamp. The ultraviolet source may be configured to emit light in the range of 100 nm-400 nm. The ultraviolet source may be configured to emit light in the range of 120 nm-400 nm.

In one or more exemplary embodiments, the ultraviolet light source operates at a wavelength in the range of 185 nm-254 nm. In one or more exemplary embodiments, the ultraviolet light source may be configured to operate at a wavelength in the range of 185 nm-254 nm to cause break down the waste gas into one or more primary gaseous by-products. The wavelength of the ultraviolet light source can be varied based on the waste gas. The spectrum of the UV light source may contain wavelengths outside of the ultraviolet range, and the ultraviolet light may be considered a light source and/or an energy source.

In one or more exemplary embodiments, the ultraviolet source may be positioned inside the photochemical reactor. In one or more example systems, the ultraviolet source may be positioned outside the photochemical reactor. In one or more exemplary embodiments, the photochemical reactor, and/or the absorption reactor may be transparent. In one or more exemplary embodiments, a portion, such as a section, of the photochemical reactor, and/or the absorption reactor may be transparent. In one or more exemplary embodiments, the inside of the photochemical reactor has a material composition characterized by a high reflectivity and/or a low absorption or extinction in the spectrum of the UV light source. In an exemplary embodiment, such material composition is aluminum, such as anodised aluminum or a foil of aluminum or anodised aluminum. In another exemplary embodiment, such material composition of an inside Polytetrafluorethylen (PTFE).

In one or more exemplary embodiments, the system and method is configured to control the intensity of the ultraviolet light. For example, the system can include a controller. The controller can be configured to control the intensity of the ultraviolet light automatically. The controller can be configured to control the intensity of the ultraviolet light based on or in response to user input or input received from a sensor monitoring conditions in the photochemical reactor.

In one or more exemplary embodiments, producing reactive radicals comprise producing reactive radicals from the waste anesthetic and/or refrigerant gas, from ambient gas such as O₂ (g) and H₂O(g) comprised in the waste anesthetic and/or refrigerant gas, and/or from one or more additives introduced into the photochemical reactor.

The waste gas may be converted into one or more primary gaseous by-products through reaction with intermediate compounds produced using the ultraviolet light source. For example, the UV source can be used to break down ozone, which together with water vapor can make reactive hydroxyl radicals, which are the active intermediate compound for the breaking down of the anesthetic gas.

In one or more exemplary embodiments, the photochemical reactor may be configured to produce intermediate compounds in the form of reactive radicals, such as O(³P), O(¹D), HO₂, and/or OH, using the ultraviolet source. The reactive radicals may react with the waste gas and may break down the waste gas into one or more primary gaseous by-products.

In one or more exemplary embodiments, converting the waste gas into one or more primary gaseous by-products comprises breaking down the waste gas into one or more primary gaseous by-products, such as hydrogen fluoride (HF) and/or hydrogen chloride (HCl) and/or carbonyl fluoride (COF₂).

In one or more exemplary embodiments, breaking down waste anesthetic and/or refrigerant gas comprises a gas-phase reaction with the produced reactive radicals. The breaking down may also comprise a gas-phase reaction with one or more additives introduced into the photochemical reactor.

Major improvements have been made to the photochemical reactor in order to properly operate with waste gas, e.g. the selection of relevant wavelengths, the intensity of light, the dimensions of the reactor and the form and the mechanical design here-off, the additives to improve the reactions, the optimal operating point, and how to maintain the system in the desired operating condition.

In one or more exemplary embodiments, the photochemical reactor may be configured to output one or more by-products, such as the one or more primary gaseous by-products. The photochemical reactor can be configured to output additional substances as well. Gaseous by-products may comprise aerosol particle products. The one or more by-products of the photochemical reactor may be a mixture of gaseous and non-gaseous in certain implementations.

Example one or more primary gaseous by-products can include one or more of: O₃, NO, NO₂, CO₂, CO, HCl, and HBr. While some N₂O may be broken down in the photochemical reactor, such as 5-15%, such as 10%, it may remain as a portion of the one or more primary gaseous by-products. However, the type of one or more primary gaseous by-product can vary based on the waste gas. Other byproducts can be formed during processing in the photochemical reactor. For example, H₂O may be formed. Some examples of the one or more primary gaseous by-products can include one or more of water, carbon dioxide, and halogenated compounds. In one or more exemplary embodiments, the one or more primary gaseous by-products may comprise nitrogen dioxide (NO₂) and/or N-centered radicals.

In one or more exemplary embodiments, the one or more primary gaseous by-products comprises one or more fluorinated compounds. Examples of fluorinated compound can include, but are not limited to, carbonyl fluoride (COF₂) and/or hydrogen fluoride (HF). In one or more exemplary embodiments, the one or more the fluorinated compounds may be seen as compounds having fluorine.

In one or more exemplary embodiments, the one or more primary gaseous by-products includes hydrogen fluoride (HF) and/or hydrogen chloride (HCl). In one or more exemplary embodiments, the one or more primary gaseous by-products includes fluoroketone.

In one or more exemplary embodiments, the photochemical reactor may be configured to break down the waste gas into one or more of: hydrogen fluoride (HF) and/or hydrogen chloride (HCl) and/or other haloacids.

In some exemplary embodiments, the photochemical reactor comprises two or more photochemical reactor chambers connected in series, each photochemical reactor chamber comprising an ultraviolet light source. The method and system then comprise conveying the waste anesthetic and/or refrigerant gas and produced primary gaseous by-products from a first photochemical reactor chamber in the series to a last photochemical reactor chamber in the series, before it is conveyed to the absorption reactor. In one or more exemplary embodiments, part of the gas from the last photochemical reactor chamber can be re-circulated, i.e. can be provided as an input for the first reactor chamber.

The photochemical reactor may be configured to output the one or more primary gaseous by-products to the absorption reactor. For example, the photochemical reactor, such as a last photochemical reactor chamber in a series of chambers, may be fluidly connected to the absorption reactor, such as through a tube and/or connection.

In one or more exemplary embodiments, the photochemical reactor is configured to operate at a temperature less than 200° C. In an exemplary embodiment, the method comprises maintaining an operation temperature inside the photochemical reactor between 0° C. and 90° C., such as between 20° C. and 70° C. For example, the specific temperature may be dependent on the nature of the particular waste gas and a sensed efficiency of breaking down the waste gas into the one or more primary gaseous by-products. Further, if dry air is used, high temperatures may reduce the functionality of the ultraviolet source.

In one or more exemplary embodiments, the system may comprise an absorption reactor. In one or more exemplary embodiments, the absorption reactor may be connected in series with the photochemical reactor. For example, an input of the absorption reactor may be an output of the photochemical reactor. The absorption reactor can be configured to receive the one or more primary gaseous by-products.

Advantageously, with regards to the absorption reactor, the selection of the medium, the tower dimensions, form and mechanical design, the optimal operation conditions such as pH and temperature, and how to maintain the system at the desired operating point can allow for the destruction of waste gas in the system.

As a result of the waste gas destruction in the photochemical reactor, the one or more primary gaseous by-products coming from the photochemical reactor may contain some reaction products, such as water, CO₂, and organic compounds. Meanwhile, non-destructed waste gas leaving the photochemical reactor are not a concern as its concentration is expected to be negligible.

The fluorine atoms in the gases can be part of the one or more primary gaseous by-products other than water, and CO₂. The one or more primary gaseous by-products may comprise fluorine-containing by-products, such as carbonyl fluoride (COF₂) or hydrogen fluoride (HF). HF is toxic and corrosive and cannot simply be released to the outdoor atmosphere and needs to be removed, and HF is highly soluble in water. COF₂ may spontaneously react in contact with water into HF and CO₂, so also it may need to be removed. For the removal of the one or more primary gaseous by-products coming from the photochemical reactor, an absorption reactor, such as an aqueous scrubber, can be integrated in series with the photochemical reactor. In the absorption reactor, a gas stream, such as from the one or more primary gaseous by-products, can be bubbled through a liquid containing calcium ions, such as a mixed calcium hydroxide/calcium chloride solution, such as limewater, to neutralize the one or more primary gaseous by-products. The act of passing through the absorption reactor can be called scrubbing.

In one or more exemplary embodiments, the absorption reactor comprises a bubble column. In one or more exemplary embodiments, the one or more primary gaseous by-products are bubbled through the liquid containing calcium ions in the absorption reactor. In one or more exemplary embodiments, a bubble column may be seen as an apparatus, such as a cylindrical column, e.g., a vertical cylindrical column, filled with liquid, at the bottom of which the one or more primary gaseous by-products are inserted and bubbled to the top. Techniques for keeping the bubbles small, to maximize gas-liquid contact area, such as stationary meshes throughout the column can be used.

For capturing of F, the gas from the photochemical reactor can be dispersed enough when bubbling through the absorption reactor. The contact time for the gas bubbles to be in contact with the aqueous CaCl₂) solution can be long enough to maximize mass transfer of HF or COF₂ gas from the bubbles into solution, where transition to F—can take place. In one or more exemplary embodiments, a tube formed reactor in a vertical direction can be advantageous.

In one or more exemplary embodiments, the absorption reactor may comprise liquid containing calcium ions. In one or more exemplary embodiments, the absorption reactor may comprise calcium chloride liquid. In one or more exemplary embodiments, the one or more primary gaseous by-products are bubbled through the liquid containing calcium ions. In one or more exemplary embodiments, the one or more primary gaseous by-products may be bubbled through the calcium chloride (CaCl₂)) solution.

In one or more exemplary embodiments, the liquid could contain water and silver ions, for example for the breakdown of bromide. The liquid containing calcium ions and/or silver ions can alternatively be another type of precipitating ion. Calcium ions and/or silver ions can be considered precipitating ions. The liquid could contain calcium ions and a buffer. The liquid could contain calcium ions and an inert liquid. The liquid may be calcium ions dissolved in a liquid.

An advantage of the absorption reactor may be to remove toxic HF, such as from the one or more primary gaseous by-products. The COF₂, such as COF₂ from the photochemical reactor, may spontaneously hydrolyze into HF and CO₂ upon contact with water, and HF is water soluble. Therefore, the first step of the absorption reactor may be to dissolve the HF of the one or more primary gaseous by-products in the water into H⁺ and F⁻. The presence of Ca2+ ions in solution may lead to precipitation of poorly soluble CaF₂ salt. The formed CaF₂, such as one or more secondary by-products, is inert and is readily removable from the absorption reactor, such as either continuously or regularly, e.g. at service intervals. Further, the CaF₂ salt potentially has value as a recovery substance as CaF₂ may be used as a source of F for the electronics industry. The precipitation of CaF₂ effectively takes place in the absorption reactor as long as enough Ca2+ is present, which means that when the concentration becomes too low, the precipitation will be limited, at which point fresh liquid containing calcium ions, such as CaCl₂), such as limewater, can be introduced into the absorption reactor.

The Ca2+ concentration in the absorption reactor can be maintained be as high as possible and constant over time. This can be achieved by adding enough CaCl₂) to not only saturate the solution, but to have additional solid CaCl₂) added to the solution. This means that the solution is supersaturated with respect to CaCl₂) and this additional solid CaCl₂) will act as a Ca2+buffer. This means adding more CaCl₂) than the solubility limit in water of pH 6-8.

Besides dissolved HF, CO₂ from the one or more primary gaseous by-products also can make the liquid containing calcium ions in absorption reactor more acidic. The pH of the solution can be controlled, because if the solution is too basic, calcium carbonate (CaCO₃) can precipitate instead of CaF₂. But if the solution has too low pH, the dissolved HF may not dissociate into H⁺ and F⁻, and CaF₂ may not form. The one or more by-products, such as one or more primary gaseous by-products, from the photochemical reactor may comprise nitrogenous species, like nitrogen dioxide (NO₂) and N-radicals, which result from the photolytic oxidation of nitrous oxide (N₂O) by reactant radicals. Scrubbing some of these species through the absorption reactor may result in the formation of nitrate ions in the water. However, calcium nitrate (Ca(NO₃)₂) is much more soluble, and will not precipitate and therefore it will not disturb the fluoride scrubbing process.

Optimal function of the absorption reactor can be provided by the countercurrent contact of the up-flowing gas, such as the one or more primary gaseous by-products, with the downflowing liquid stream together with the use of a perforated plate for fine distribution of the gas bubbles to increase the gas-liquid contact zone, and thus promote the absorption performance. In one or more examples, the disclosure can include an absorption reactor with the right geometry and operation conditions for maximizing WAG elimination and efficient absorption, precipitation, and collection of the precipitate (filtering) to ensure that all HF is captured by providing an overall optimal mass balance of the gases, liquid, and precipitates. The system may be configured to remove the one or more nongaseous secondary by products, such as solid CaF₂. The filtering of produced CaF₂ can take place at the time of service of the machine.

The operating conditions of the absorption reactor may also be monitored, including pH, conductivity/capacitance, and temperature of the medium, such as by the control unit, and adequate control actions can be performed to make sure the optimum performance and safety of the process. For example, monitoring can include indicating a warning or signal of a need to replace any liquid, such as because of saturation. Monitoring can include operating a shut-down mechanism with bypass of the reactor in case of major failure.

In one or more exemplary embodiments, to prevent potential corrosion problems from the presence of HF, the absorption reactor can be formed of a corrosion resistant material, e.g., glass-reinforced plastic (GRP) for the absorption reactor's body material instead of the use of exotic materials with their associated cost.

In one or more exemplary embodiments, the absorption reactor may be configured to connect with the photochemical reactor using a controllable connection, such as using a flow control equipment, e.g., a gas flow valve. In one or more exemplary embodiments, the absorption reactor may be configured to receive and/or collect the one or more primary gaseous by-products from the photochemical reactor. In one or more exemplary embodiments, the absorption reactor is configured to convert the one or more primary gaseous by-products into one or more secondary by-products. In one or more exemplary embodiments, converting the one or more primary gaseous by-products into one or more secondary by-products comprises one or more of decomposing, degrading, and dissolving, in the absorption reactor, the one or more primary gaseous by-products.

As an example, the absorption reactor is configured to convert the one or more primary gaseous by-products of one or more of calcium fluoride, CaF₂, and calcium nitrate, Ca(NO₃)₂ into one or more secondary by-products. In one or more exemplary embodiments, an oxidizing agent such as UV light and/or ozone can be used. Secondary by-products may include, for example CaF and Ca(NO₃)₂.

In one or more exemplary embodiments, the absorption reactor may be configured to convert the one or more primary gaseous by-products into the one or more secondary by-products using a liquid containing calcium ions, such as liquid having Cations, for example calcium chloride, CaCl₂), and/or calcium carbonate, CaCO₃.

In one or more exemplary embodiments, the one or more secondary by-products comprises solid calcium fluoride and/or calcium chloride. Solid calcium fluoride can be a precipitate. In one or more exemplary embodiments, the one or more secondary by-products may be non-toxic. In one or more exemplary embodiments, non-toxic may be seen as non-hazardous. In other words, the one or more by-products may comprise a product, a substance or a chemical that does not cause adverse health effects.

In one or more exemplary embodiments, the system may be configured to output the one or more secondary by-products. In one or more exemplary embodiments, the one or more secondary by-products may comprise one or more secondary gaseous by-products. In one or more exemplary embodiments, the one or more secondary by-products may comprise one or more secondary non-gaseous by-products.

In one or more exemplary embodiments, the one or more secondary by-products may comprise non-toxic by-products, such as H₂O, N₂, CO₂, and/or O₂. In one or more exemplary embodiments, the one or more secondary by-products may comprise one or more secondary non-gaseous by-products, such as calcium fluoride, CaF₂. In one or more exemplary embodiments, the one or more secondary by-products may form a precipitate. In one or more exemplary embodiments, the absorption reactor is configured to maintain pH of the liquid containing calcium ions in the range of 6 to 8.

In one or more exemplary embodiments, the absorption reactor may comprise liquid containing calcium ions. The liquid containing the calcium ions may have a pH in the range of 6 to 8. The liquid containing the calcium ions may have a pH in the range of 6.5 to 7.5. The liquid containing the calcium ions may have a pH in the range of 6.9 to 7.1.

In one or more exemplary embodiments, the system may be configured to maintain the pH of the calcium chloride, CaCl₂), in the range of 6 to 8. In one or more exemplary embodiments, the system may be configured to maintain the pH of the calcium carbonate, CaCO₃ in the range of 6 to 8.

In one or more exemplary embodiments, the system may be configured to control the concentration of the liquid containing the calcium ions. In one or more exemplary embodiments, the system may be configured to maintain the pH of the liquid containing calcium ions in the range of 6 to 8 by introducing fresh liquid containing calcium ions.

The absorption reactor may maintain a particular pH. For example, in one or more systems the absorption reactor can have a pH of 6-8. Having a pH of 6 or higher can allow for HF dissociation in water to H⁺ and F⁻, which can enable precipitation of calcium chloride.

Having a pH of 8 or lower can be used because the high Ca2+ concentration in the absorption reactor can, at high pH, lead to CaCO₃ precipitation. The waste gas can come from a patient, who breathes out CO₂. CO₂ also gets produced by the photochemical reactor during the breakdown of the anesthetic halogenated gas. CO₂ in contact with water can lead to formation of bicarbonate and carbonate ions at high pH. This carbonate will precipitate with Ca into CaCO3. This unwanted precipitation would reduce the amount of available Ca for CaF₂ formation. Formation would require separation between CaF₂ and CaCO₃ if the byproduct should be used elsewhere. Without CaCO₃, the CaF₂ would be much cleaner and can potentially be used in other applications.

In one or more exemplary embodiments, the one or more secondary by-products may comprise one or more secondary gaseous by-products and/or one or more secondary non-gaseous by-products. In one or more exemplary embodiments, the absorption reactor may be configured to output the one or more secondary by-products. The absorption reactor may be configured to output the one or more secondary by-products into the environment. The absorption reactor may be configured to output the one or more secondary by-products into a container.

In one or more exemplary embodiments, the method and system may be configured to control the quantity of the liquid containing calcium ions in the absorption reactor. In one or more exemplary embodiments, the absorption reactor may be configured to control the amount of liquid containing calcium ions, such as using a liquid flow controller, e.g., a liquid valve, to adjust the amount of liquid containing calcium ions in the absorption reactor.

In one or more exemplary embodiments, the absorption reactor may be configured to receive the one or more primary gaseous by-products from the photochemical reactor. In one or more exemplary embodiments, the absorption reactor may be configured to receive the waste gas, and the one or more primary gaseous by-products from the photochemical reactor. For example, the absorption reactor may be configured to receive waste gas that has not been fully broken down from the photochemical reactor.

In one or more exemplary embodiments, the absorption reactor may comprise a feedback connection to the photochemical reactor.

In one or more exemplary embodiments, 90% of the waste gas can be converted to the secondary by-products that are non-toxic. In one or more exemplary embodiments, at least 90% of the waste gas can be converted to the secondary by-products that are non-toxic. In one or more exemplary embodiments, at least 95% of the waste gas can be converted to the secondary by-products that are non-toxic. In one or more exemplary embodiments, at least 99% of the waste gas can be converted to the secondary by-products that are non-toxic.

In one or more exemplary embodiments, 90% of the waste gas can be converted to the secondary by-products that are non-toxic. In one or more exemplary embodiments, at least 90% of the waste gas can be converted to the secondary by-products that are non-toxic. In one or more exemplary embodiments, at least 95% of the waste gas can be converted to the secondary by-products that are non-toxic. In one or more exemplary embodiments, at least 99% of the waste gas can be converted to the secondary by-products that are non-toxic.

In one or more exemplary embodiments, 90% of N₂O in the waste gas can be converted. In one or more exemplary embodiments, at least 95% of N₂O in the waste gas can be converted. In one or more exemplary embodiments, at least 99% of the N₂O in the waste gas can be converted. In one or more exemplary embodiments, between 15% and 99.999% of the N₂O in the waste gas can be converted. The absorption reactor can be configured to convert any remaining N₂O from the waste gas, such as in the one or more primary gaseous byproducts.

In an example scenario, the one or more primary gaseous by-products may comprise fluorine, such as carbonyl fluoride (COF₂) or hydrogen fluoride (HF). HF may be toxic and/or corrosive, and therefore should not simply be released to the outdoor atmosphere. For example, COF₂ may spontaneously react in contact with water into HF and CO₂. The one or more primary gaseous by-products are bubbled through a liquid containing calcium ions, such as calcium hydroxide, and/or calcium chloride solution to neutralize the one or more primary gaseous by-products.

The absorption reactor may be configured to remove HF. Any formed COF₂ in the photochemical reactor may spontaneously hydrolyses into HF and CO₂ upon contact with water, and HF is water soluble. Therefore, in the absorption reactor, the HF may be dissolved in the water into H⁺ and F⁻. The presence of Ca₂+ ions in the liquid containing calcium ions may lead to the precipitation of poorly soluble CaF₂ salt. The formed CaF₂ is inert and may readily be removable, either continuously or regularly, e.g., at service intervals. The formed CaF₂ may potentially have value as a recovery substance as CaF₂ is the main source of F for the electronics industry.

Besides dissolved HF, dissolved CO₂ may make the liquid containing calcium ions acidic. In one or more exemplary embodiments, the acidified liquid containing calcium ions may be substituted, such as replaced and/or maintained, such as by adding fresh liquid to the absorption reactor, e.g., fresh CaCl₂), the pH of the liquid containing calcium ions in between 6 to 8.

In an example scenario of operation of an example method or system of the disclosure, the photochemical reactor may receive ozone, 03, and/or H₂O as additives and a waste gas such as nitrous oxide and/or hydrofluoroethers, HFE. One or more of this waste gas can be, for example, from anesthetic waste gas. The photochemical reactor may produce reactive radicals using the ultraviolet light from the ultraviolet source. The system, such as via a control unit, may be configured to control the frequency and intensity of the ultraviolet light produced by the ultraviolet source.

The ozone under the influence of the ultraviolet light may produce singlet oxygen O(¹D).

O₃+ultraviolet light→O(¹D)+O₂ (eq. 1)

Singlet oxygen, O(1D), due to its high reactivity, may react with water, nitrous oxide and/or hydrofluoroethers, yielding hydroxyl radicals (eq. 2), nitrogen monoxide molecules (or molecular nitrogen and oxygen) (eq. 3), hydroxyl and/or fluorine monoxide radicals (eq. 4), or an organic radical.

O(¹D)+H₂O→2HO* (eq. 2)

O(¹D)+N₂O→2NO/(N₂+O₂) (eq. 3)

O(¹D)+HFE→HO*/(OF*+R) (eq. 4)

The hydroxyl radical formed in eq. 2 and eq. 4 may continue reactions with destruction of the fluorinated anesthetic gases:

HO*+HFE→H₂O+RO₂ (eq. 5)

Depending on the light wavelength, emissions can produce additional ozone through the photolysis of molecular oxygen, as well as OH radicals from H₂O photolysis.

O(¹D) also collides with the other molecules present in the gas stream (M: N₂, O₂, Ar, CO₂) giving ground state oxygen (O(³P))(Eq. 6), reacting with molecular oxygen to generate ozone (Eq. 7) which can be photolyzed again in (Eq. 1), restarting the production of OH radicals.

O(¹D)+M→O(³D)+M (eq. 6)

O(¹D)+O₂+M→O₃+M (eq. 7)

In an example scenario, the photochemical reactor may receive a waste gas, such as sevoflurane, and oxygen as an additive. In certain systems, the additives may improve reactor performance, such as improving removal efficiency and/or byproduct formation.

Further changes to the system can include one or more of: adjusting the relative humidity, adding a catalyst/accelerator like NOx, or a radical quencher, as well as oxygen gas to optimize reaction stoichiometry for desired products from the reactor. Concentration of additives, flow rate of the additives, the intensity of light, and the total flow through the system may be controlled, by the system and/or control unit, based on measurements from the system. An example fluoride containing byproduct from the photochemical reactor is carbonyl fluoride, as it is not as corrosive as HF. By controlling the oxygen concentration relative to the system concentration, a reaction stoichiometry can be achieved, favoring COF₂ production over HF. An example for sevoflurane can be produced (eq. 8):

4C₄H₂F₇O+9O₂→14COF₂+4H₂O+2CO₂ (eq. 8)

A feature of some of the anesthetic gases which can be waste gas, such as desflurane and sevoflurane, is that they have fewer hydrogen atoms relative to other hydrocarbons—they are halocarbon compounds. Thus, the OH radical which is often reacting with the hydrogen atom on other hydrocarbons may not always be successful as it does not react with halogen atoms (cannot break the carbon halogen bond). An alternative approach is to use the highly reactive singlet oxygen atom O(1D). This means that while there will be some enhancement due to the presence of water vapor, this is counteracted by the inhibitory effect that the OH radical has on ozone concentration due to OH+O3→HO2+O2.

In one or more exemplary embodiments, the system comprises a control unit. The control unit may be configured to improve and/or optimize performance of the method and system. The control unit may be configured to perform startup and/or shutdown of the system. The control unit can be configured to monitoring the method and system for any faults or mis-functioning. The control unit can be configured for continuously monitoring the method and system.

The role of the control unit can be to monitor the state of the process and take adequate actions to guarantee the optimum performance and the safety of the process. The monitoring can be performed with the aid of, for example, a series of traditional sensors, e.g. for flow, pressure, temperature, humidity, pH, and capacitance/conductivity of the medium and/or a specific designed non-linear infrared (NLIR) sensor based on gas spectrometry to detect the concentration of waste gas, N₂, O₂, and any other required gas at the inlet and outlet of each step, and in the exhaust of the system.

In general, the control unit receives an input and determines, based on the input and the state of the operation, whether an adjustment of one or more operational parameters is to be made. The input and the adjustment may relate to the efficiency, durability, or safety of the operation of the system.

In an exemplary embodiment, the system comprises:
a control unit for monitoring and controlling the destruction of waste anesthetic and/or refrigerant gas in the system;
a sensor for sensing a value related to a first operational parameter indicative of an efficiency of the breaking down of the waste anesthetic and/or refrigerant gas into one or more primary gaseous by-products; and
an actuator for regulating a second operational parameter impacting the breaking down of the waste anesthetic and/or refrigerant gas into one or more primary gaseous by-products;
   wherein the control unit is configured to:
receive a sensed value from the sensor;
based on at least the sensed value, determine an adjustment of the second operational parameter; and
sending a signal to the actuator to effectuate the determined adjustment of the second operational parameter.

The first and second operational parameters may be the same operational parameter.

In the following, several exemplary operational parameters are described. For each operational parameter, there may be a sensor to sense a value related to the operational parameter. In the following, several exemplary sensors for sensing or measuring or determining a value related to the operational parameter are described. For each operational parameter, there may be an actuator for regulating the operational parameter. In the following, several exemplary actuators for regulating the operational parameters are described.

For example, to maintain the system in the desired optimal operating condition, several operational parameters such as one or more of: flow rates, temperatures, humidity, pH levels, and gas concentrations can be constantly monitored and regulated through the control unit. Also, in case of any device failure, the control unit can be configured to decide the safest reconfiguration strategy to mitigate impact on operation of the system and its environment. The advanced monitoring and control algorithms can allow for optimal and safe operation of the system in both normal and failure modes.

The control unit, or a method step performing such function, can be configured to, based on the sensed values or monitored signals and identified system state, one of the following:
1—Control the flow rate or rates of the waste gas to be processed and/or creating of first and secondary by-products through the system.
2—Control the concentration and flow of additives to the photochemical reactor.
3—Control the light wavelength and light intensity in the photochemical reactor.
4—Control of temperature and the pH of the medium in absorption reactor.
5—Or any other control actions deemed necessary to improve performance, including recirculation in case of incomplete reactions;
6—Reconfiguration of the system in case of a component or reaction failure to mitigate the safety risk and performance degradation impact.

In one or more exemplary embodiments, the control unit may be an electronic device, such as a controller, a processor, a computer, a tablet, a mobile phone, a laptop, and/or a device comprising programmable circuitry. In one or more exemplary embodiments, the control unit may comprise memory circuitry, processor circuitry, and an interface. The control unit may be configured to receive user input.

In one or more exemplary embodiments, the control unit is configured to control the photochemical reactor and the absorption reactor by regulating operational parameters of the system. In one or more exemplary embodiments, the control unit may be configured to control the photochemical reactor by regulating operational parameters of the photochemical reactor. In one or more exemplary embodiments, the control unit may be configured to control the absorption reactor by regulating operational parameters of the absorption reactor. In one or more exemplary embodiments, the photochemical reactor may comprise the control unit. In one or more exemplary embodiments, the absorption reactor may comprise the control unit.

Operational parameters related to the photochemical reactor may include one or more of: waste gas inflow into photochemical reactor, flow rate of additives into photochemical reactor, concentration of the additives in the photochemical reactor, outflow of the one or more primary gaseous by-products, recirculation of the one or more primary gaseous by-products, ultraviolet light intensity of the photochemical reactor, pH of the photochemical reactor, temperature inside the photochemical reactor, pressure inside the photochemical reactor, humidity inside the photochemical reactor, a position of the UV light source, a wavelength spectrum of the UV light source, a speed or rate of a swirling mechanism in the photochemical reactor, residence time of gases in the photochemical reactor,

Operational parameters related to the absorption reactor may include one or more of: a liquid level and/or pollution of the absorption reactor, inflow of the one or more primary gaseous by-products into the absorption reactor, pH of the liquid containing calcium ions, a bubbling rate of one or more primary gaseous by-products through the liquid, outflow of the one or more secondary by-products from the absorption reactor, temperature of the absorption reactor, precipitation of the one or more secondary by-products, rate of conversion of the one or more gaseous primary by-products into the one or more non-gaseous secondary by-products, flow rate of fresh liquid containing calcium ions into the absorption reactor

Operational parameters related to the system, including the photochemical and absorption reactors, may include one or more of: temperature and/or humidity at particular points in the system, flow rate through the system, such as flow rate through the photochemical reactor and/or the absorption reactor, input gas composition, such as the waste gas composition, output gas composition,

Exemplary sensors for sensing values related to operational parameters may include one or more of: CO₂ sensor such as a photoacoustic machine for monitoring CO₂, N₂O sensor such as a photoacoustic machine for monitoring N₂O, a flow sensor, a pressure sensor, a temperature sensor, a humidity sensor, a pH sensor, a dispersive infrared sensor, near-infrared sensor, a capacitance sensor, a conductivity sensor, a non-linear mid-infrared sensor,

One or more sensors, such as the non-linear mid-infrared sensor, may be configured for detecting the waste gas, such as a concentration of waste gas, a concentration of the one or more primary gaseous by-products, a concentration of the one or more primary gaseous by-products. One or more sensors, such as the conductivity sensor may be configured to indicate the time for removal of precipitate in the absorption reactor. One or more sensors may provide for indirect measurements and indications of changes to the pH or liquid conductivity.

Exemplary actuators for regulating operational parameter may include one or more of: a cooling system for regulating a temperature inside the photochemical reactor and/or the absorption reactor, a heating system for regulating a temperature inside the photochemical reactor and/or the absorption reactor, a pump and/or a valve for regulating a pressure inside the photochemical reactor and/or the absorption reactor, a pump and/or a valve and/or a nozzle for regulating a gas flow rate to or from the photochemical reactor and/or the absorption reactor, where the regulation of a gas flow may be used to regulate concentrations and compositions of gases in the reactor,

Actuators may be implemented by different devices such as switches, electromotors, servos, transducers, piezoelectric devices.

The cooling system mentioned above may be based on air and be comprised of fans and potentially flanges to enhance heat transfer. The cooling system can be based on water, either in a closed system, or running through, using tap water and a drain available where the setup is to be used.

The following table summarizes some exemplary operational parameters, ways to regulate them and preferred values.

| | | |
|---|---|---|
| Operational parameter | Ways to regulate | Preferred values/ranges/ratios |

Photochemical reactor

| | | |
|---|---|---|
| Temperature | Cooling/heating of reactor from | First preferred operational |
| | outside by air/water circulated | range: 20° C. to 90° C. |
| | flow. | Second preferred operational |
| | Controlling inlet temperature of | range: 40° C.-60° C. |
| | waste anesthetic gas and | |
| | additives | |
| Pressure | Pumps and/or Valves | Around or below atmospheric |
| | | pressure to avoid leaks out of |
| | | system. |
| | | First preferred operational |
| | | range: −3.0 PSIG to +3.0 PSIG |
| | | (pounds per square gauge) |
| | | Second preferred operational |
| | | range: −0.5 PSIG to +0.5 PSIG |
| Flow rate of waste gas | Gas flow valve/nozzle | 0.25 m³/2 mins |
| into photochemical | | Up to 6 lₙ/min, but ultimately |
| reactor | | depends on the size of the |
| | | system. |
| Waste gas | Gas flow valve/nozzle | below 1 vol % |
| concentration | | For high WAG's concentrations |
| | | amount of photoreactors can be |
| | | increased |
| Additives flow rates | Gas flow valve/nozzle | From 0% up to 25% of the |
| | | nominal input flow rate |
| Additive concentration | | O₃ in reactor from 100 ppm to |
| | | 8200 ppm. |
| | | Inlet O₃: up to few vol % |
| | | (depends on WAG's |
| | | concentration) |
| | | Outlet O₃: below 1 ppm |
| UV light intensity | Lamp power supply, | Typical UV lamp power from |
| | mechanism to block light | 50 W-1.000 W. |
| | | Preferably increase with |
| | | increasing WAG concentration. |
| Total flow through | Flow meter | Typical operational range: 1 |
| reactor | | lₙ/min-6 lₙ/min, depending |
| | | amount of waste gas to be |
| | | purified (e.g. size if holding tank, |
| | | number of operating theatres, |
| | | discharged refrigerant system, |
| | | etc). |
| Humidity | | From 20% up to saturated air |
| | | (100% relative humidity). Highly |
| | | dependent upon whether the |
| | | waste gas is taken directly from |
| | | the source (e.g. anesthesia face |
| | | mask or discharged refrigerant |
| | | system) or from an ambient |
| | | atmosphere polluted with the |
| | | waste gas. |

Absorption reactor

| | | |
|---|---|---|
| Gas inflow from | Gas flow valve | Equal to the total flow through |
| photochemical reactor | | photochemical reactor |
| Bubble size | | Depending on mixer speed from |
| | | 0.1 mm to 50 mm in diameter |
| Amount of liquid | liquid valve | Typically 5-20 liters, but may |
| containing calcium ions | | be scaled depending on |
| | | application. |
| pH | Adding a supersaturated | 6-8, such as 6.5-7.5 such as |
| | solution of CaCl₂. | 6.9-7.1 |
| Temperature | | Typically 30° C. to 60° C., but |
| | | variable depending on flow |
| | | rates and ambient temperatures |
| | | and conditions. |

In one or more exemplary embodiments, the method comprises sensing a pH value of the liquid in the absorption reactor; and, in response to the sensed pH value, controlling the breaking down of waste anesthetic and/or refrigerant gas by regulating one or more photochemical reactor operation parameters selected from:
flow rate of waste anesthetic gas into the photochemical reactor, flow rate of additives into the photochemical reactor, flow rate of the one or more primary gaseous by-products out of the photochemical reactor, flow rate of gas recirculated from the photochemical reactor and back into the photochemical reactor, intensity of the ultraviolet light, pH inside the photochemical reactor, temperature inside the photochemical reactor, pressure inside the photochemical reactor.

Equivalently, the system may comprise a pH sensor in the absorption reactor and a control unit configured to performing the controlling according to the above method.

In one or more exemplary embodiments, the method comprises sensing a HF content in the primary gaseous by-products conveyed to the absorption reactor; and, in response to the sensed HF content, controlling the breaking down of waste anesthetic and/or refrigerant gas by regulating one or more photochemical reactor operation parameters selected from:
flow rate of waste anesthetic gas into the photochemical reactor, flow rate of additives into the photochemical reactor, flow rate of the one or more primary gaseous by-products out of the photochemical reactor, flow rate of gas recirculated from the photochemical reactor and back into the photochemical reactor, intensity of the ultraviolet light, pH inside the photochemical reactor, temperature inside the photochemical reactor, pressure inside the photochemical reactor.

Equivalently, the system may comprise a HF sensor in the connection between the photochemical reactor and the absorption reactor and a control unit configured to performing the controlling according to the above method.

The control unit can be configured to determine, such as based on the predefined and embedded models and values, that whether the system is operating within the safe and desirable operating envelope. If yes, the control unit can be configured to provide a notification, such as to operators and the personnel in the operating room.

If no, the control unit can be configured to perform one of the following: determining and isolating the source of the malfunctioning of the system as closely as possible based on the pre-defined and embedded algorithms; determining the consequence and the level of risk to the personnel, the patient and the environment such as minor, major, critical if the system continues to operate at the faulty condition; and identifying the best course of actions such as continuing the operating with the reduced functionality, reconfiguring the system, or full shutdown based on the calculations using the embedded models and algorithms. Certain decision criteria can include to minimize the impact on the performance and operation, to optimize waste gas elimination, and to maintain the safety of the patient, operators, and the system.

Depending on the severity of the fault and the potential consequences on the safety, operation, and performance, the control unit can be configured to reconfigure the system within the given authorities. Further actions may be required by the operators and personnel if the fault severity is beyond the control unit action plan.

The operating status of the system (normal or faulty) with all necessary information including but not limited to the system performance, input and output waste gas concentrations, the fault level, possible root cause of the existing fault if any, suggested and implemented actions by the control unit, and the required actions by the operator can be illustrated using an adequate and user-friendly Human-Machine Interface (HMI). The HMI can also be used to receive the required inputs from the operators such as startup and shutdown commands, flow rate setting, and re-configuration modes in a normal and faulty configuration.

Temperature can have a complicated effect. On the one hand reactions become faster as temperature increases. On the other hand, ozone breaks down at temperatures above 70° C. in a process catalyzed by surfaces. Lamps become less efficient, and their lifetime is reduced at high temperature. In one or more exemplary embodiments, the control unit may be configured to control a cooling unit to maintain an operation temperature inside the photochemical reactor between 0° C. and 90° C., such as between 20° C. and 70° C., such as between 20° C. and 50° C. A temperature below 50° C. in the photochemical reactor may be preferred in order to enhance the ozone concentration as much as possible without degrading lamp lifetime unnecessarily and still enjoying the benefit of increased reaction rate.

In one or more exemplary embodiments, the system is configured to treat the waste gas in continuous flow state and/or in batches. For example, the system can continuously receive waste gas. The system can also receive gas in batches, such as from a buffer tank.

In one or more exemplary embodiments, the system may be configured to treat the waste gas in continuous flow state. In one or more exemplary embodiments, the system may be configured to treat the waste gas dynamically. In one or more exemplary embodiments, the system may be configured to treat the waste gas in batches. In one or more example systems, the continuous flow state may be seen as the waste gas may be obtained by the photochemical reactor continuously. In one or more exemplary embodiments, treating the waste gas in batches, by the photochemical reactor, may be seen as the photochemical reactor may be configured to treat the waste gas periodically or treat certain amount of the waste gas during a given time, e.g., 0.25 m³/2 mins.

In one or more exemplary embodiments, the photochemical reactor and/or the absorption reactor comprises a swirling mechanism. In the photochemical reactor, the swirling mechanism may be configured to receive the waste gas. In the absorption reactor, the swirling mechanism may be configured to receive the one or more primary gaseous by-products. In the absorption reactor, the swirling mechanism may comprise a liquid containing calcium ions.

In one or more exemplary embodiments, the system is not a scavenging or capture system of the waste gas. In one or more exemplary embodiments, the system can capture the one or more primary by-products and/or the one or more secondary by-products. In one or more exemplary embodiments, the system can be used in conjunction with a capture system. For example, this combination can be used as a centrally located unit within a hospital serving as an on-site destruction unit where previously captured gas can disposed of safely.

The photochemical reactor and/or the absorption reactor may comprise a corrosion resistant material, e.g., glass-reinforced plastic (GRP) for the reactor, e.g., photochemical reactor and/or absorption reactor, body material. Using glass-reinforced plastic (GRP) as reactor body material may improve the durability of the reactors and reduce the cost.

In one or more exemplary embodiments, the system may be configured to identify one or more of: one or more components failure, reaction failure, and malfunctioning of one or more components of the system. The one or more components may be seen as the components associated with the system, such as the components associated with the photochemical reactor and/or the absorption reactor, e.g., the one or more sensors.

In one or more exemplary embodiments, the system may be configured to execute a safety protocol to control the system, e.g., shutting down the system in case of emergency. In one or more exemplary embodiments, the control unit may be configured to execute a safety protocol to control the system, e.g., shutting down the power supply to system in case of emergency.

In one or more exemplary embodiments, the system may be configured to collect the one or more secondary by-products from the absorption reactor and introduce the one or more secondary by-products into the photochemical reactor.

The figures are schematic and simplified for clarity, and they merely show details which aid understanding the disclosure, while other details have been left out. Throughout, the same reference numerals are used for identical or corresponding parts.

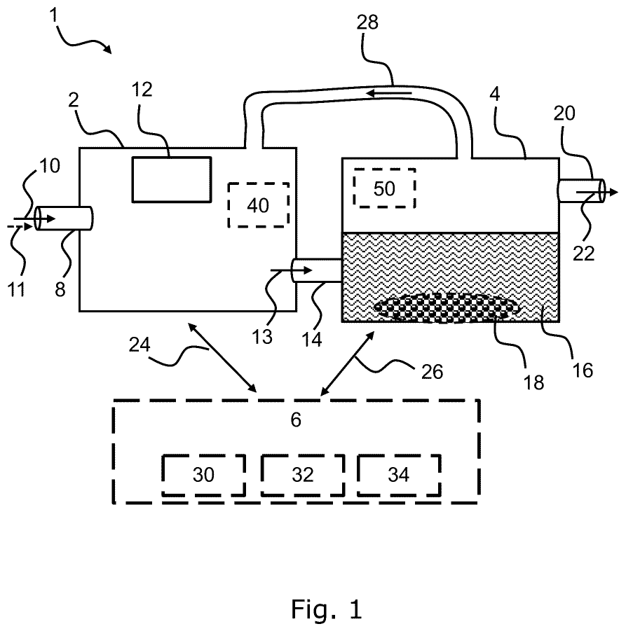

FIG. 1 is a diagram illustrating an example system 1 for waste gas treatment. The system comprises a photochemical reactor 2, and an absorption reactor 4, provided with the photochemical reactor 2 provided in series with the absorption reactor 4 provided after the photochemical reactor 2. The system may optionally comprise a control unit 6 suitable to control the main parameters to reach an effective destructive impact on the waste gas components, such as waste gas flow, temperature, pressure, pH, intensities, volumes of fluids and gasses and the like.

The photochemical reactor 2 comprises an ultraviolet light source 12. The photochemical reactor 2 comprises an inlet 8 to receive a waste gas 10. The photochemical reactor 2 comprises an outlet 14 suitable for conveying a primary gas by-product on to and into the absorption reactor 4. The photochemical reactor 2 may be configured to receive a waste gas 10 through the inlet 8. The waste gas 10 may comprise one or more of: nitrous oxide, an organohalogen gas, a halogenated anesthetic gas, and a gas containing organohalogen vapors from one or more of: solvents, pesticides, refrigerants, fire resistant oils, ingredients of elastomers and drugs, and waste gas from production and use of plastics, plasticizers, adhesives, and sealants. The waste gas 10 may be an anesthetic gas comprising one or more of: nitrous oxide, isoflurane, desflurane, and sevoflurane.

The photochemical reactor 2 may be configured to break down the waste gas 10 into one or more primary gaseous by-products 13. The photochemical reactor 2 may be configured to break down the waste gas 10 into one or more primary gaseous by-products 13 using the ultraviolet light source 12. The ultraviolet light source may be configured to emit light having wavelengths in the range of 185 nm-254 nm, preferably adapted and configured in wavelengths to match a waste gas compound to be destructively decomposed during the photochemical action.

The photochemical reactor 2 may be configured to optionally receive one or more additives 11. The one or more additives may comprise one or more of: H₂O, NOₓ, NH₃, O₃ and O₂. The photochemical reactor 2 may be configured to break down the waste gas 10 into one or more primary gaseous by-products 13 using the ultraviolet light source 12 and the one or more additives 11. The one or more primary gaseous by-products may comprise one or more fluorinated compounds, such as hydrogen fluoride (HF). The one or more primary gaseous by-products may comprise hydrogen chloride (HCl).

The photochemical reactor 2 is connected in series with the absorption reactor 4. The photochemical reactor 2 is connected in series with the absorption reactor 4 using a connector 14. The connector 14 may be a gas volve, and/or a flow regulator. The photochemical reactor 2 may be configured to control the connector 14. The photochemical reactor 2 may optionally comprise a swirling mechanism. The photochemical reactor 2 may comprise one or more sensors 40. The one or more sensors 40 may be configured to detect and/or control the one or more of: the waste gas 10 inflow into photochemical reactor 2, flow rate of additives 11 into photochemical reactor 2, the outflow of the one or more primary gaseous by-products 13 to the absorption reactor 4, ultraviolet source 12 intensity of the photochemical reactor, pH of the photochemical reactor 2, and temperature of the photochemical reactor 2.

The photochemical reactor 2 may be configured to control the formation of the one or more primary gaseous by-products 13.

The absorption reactor 4 may be configured to collect, and/or receive the one or more primary gaseous by-products 13 from the photochemical reactor 2. The absorption reactor 4 may be configured to collect, and/or receive one or more primary gaseous by-products 13 from the photochemical reactor 2 using the connector 14. The absorption reactor 4 comprises a liquid containing calcium ions 16. The absorption reactor 4 may comprise a swirling mechanism. The absorption reactor 4 may be configured to introduce the one or more primary gaseous by-products 13 into the liquid containing calcium ions 16. The one or more primary gaseous by-products 13 may be bubbled through the liquid containing calcium ions 16. The absorption reactor 4 comprises an outlet 20. The absorption reactor 4 may be configured to convert the one or more primary gaseous by-products 13 into one or more secondary by-products 18, 22. The one or more secondary by-products may comprise one or more gaseous secondary by-products 22. The one or more secondary by-products may comprise one or more non-gaseous secondary by-products 18. The one or more secondary by-products may form a precipitate in the absorption reactor 4. The absorption reactor 4 may optionally comprise feedback 28 connected to the photochemical reactor 2 for further processing in the photochemical reactor. The absorption reactor 4 may comprise one or more sensors 50. The one or more sensors 50 may be configured to detect and/or control the one or more of: inflow of the one or more primary gaseous by-products 13 into the absorption reactor 4, pH of the liquid containing calcium ions 16, bubbling rate of one or more primary gaseous by-products through the liquid containing calcium ions 16, the outflow of the one or more secondary by-products 22 from the absorption reactor, temperature of the absorption reactor, and precipitation of the one or more secondary by-products 18. The absorption reactor may be configured to maintain pH of the liquid containing calcium ions, for example in the range of 6 to 8. In one or more exemplary embodiments, the liquid containing calcium ions may comprise calcium chloride. The liquid containing calcium ions may comprise calcium hydroxide and/or calcium chloride. The absorption reactor 4 may be configured to further decompose nitrous oxide, why may be a part of the one or more primary gaseous by-products.

The absorption reactor 4 may be configured to control the formation of the one or more secondary by-products 18, 22. The control unit 6 for controlling the absorption reactor 4 may be configured to control the outflow speed and volume of the one or more secondary gaseous by-products 22. The one or more secondary by-products may comprise solid calcium fluoride and/or calcium chloride.

The optional control unit 6 may comprise memory circuitry 30, processor circuitry 32, and an interface 34. The interface may be a wired interface. The interface may be a wireless interface. The control unit 6 may communicate with the photochemical reactor 2 via a link 24, such as a wired and/or a wireless link. The control unit 6 may control the photochemical reactor 2 via the link 24. The control unit 6 may communicate with the absorption reactor 4 via a link 26, such as a wired and/or a wireless link. The control unit 6 may control the absorption reactor 4 via a link 26. The control unit 6 may be configured to execute an instruction set by a user. The control unit 6 may be configured to dynamically control the photochemical reactor 2, and the absorption reactor 4. The control unit 6 may be configured to control the one or more sensors 40, 50.

In one or more exemplary embodiments, the system 1 may comprise a flow sensor to monitor and/or control the flow rate of the waste gas 10, one or more primary gaseous by-products 13, and/or one or more secondary by-products 22. In one or more exemplary embodiments, the system 1 may comprise a flow sensor to monitor and/or control the flow rate of the one or more additives 11 into the photochemical reactor. In one or more exemplary embodiments, the system 1 may comprise a flow sensor to monitor and/or control the flow rate of fresh liquid containing calcium ions into the absorption reactor 4.

In one or more exemplary embodiments, the system 1 may comprise a pressure sensor to monitor the pressure in the photochemical reactor 2 and/or in the absorption reactor 4. In one or more exemplary embodiments, the system 1 may comprise a temperature sensor to monitor the temperature in the photochemical reactor 2 and/or in the absorption reactor 4. In one or more exemplary embodiments, the system 1 may comprise a humidity sensor to monitor the humidity in the photochemical reactor 2 and/or in the absorption reactor 4. In one or more exemplary embodiments, the system 1 may comprise a pH sensor to monitor the pH in the photochemical reactor 2 and/or in the absorption reactor 4.

In one or more exemplary embodiments, the system 1 may comprise one or more of: a dispersive infrared sensor, near-infrared sensor, a capacitance sensor, a conductivity sensor, and a non-linear mid-infrared sensor to monitor the waste gas 10, one or more of the primary gaseous by-products 13, and the one or more secondary by-products 18, 22.

In one or more exemplary embodiments, the system 1 may comprise a buffer tank configured for inflow of the waste gas, e.g., storing the waste gas and/or controlling the inflow of waste gas into the photochemical reactor 2. In one or more exemplary embodiments, the system 1 may comprise a cooling system, e.g., cooling system may be used to operate the system 1 at a temperature less than 200° C. In one or more exemplary embodiments, the system 1 may comprise a photoacoustic machine for monitoring of CO₂ and N₂O.

In one or more exemplary embodiments, the system 1 may be configured to treat the waste gas in continuous flow state and/or in batches. In one or more exemplary embodiments, the photochemical reactor 2 may comprise a swirling mechanism, such as a first swirling mechanism. The first swirling mechanism may be used to break down the waste gas into one or more primary gaseous by-products. In one or more exemplary embodiments, the absorption reactor 2 may comprise a swirling mechanism, such as a second swirling mechanism to convert the one or more primary gaseous by-products into the one or more secondary by-products.

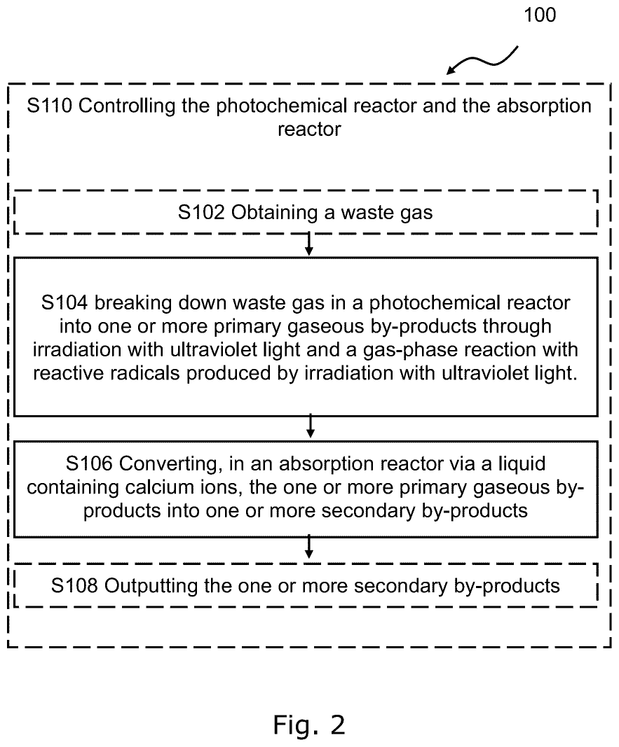

FIG. 2 shows a flow diagram of an example method 100, performed by a system according to the disclosure. The method 100 may be performed for waste gas treatment. The method 100 may be performed by the system 1 shown in FIG. 1.

In one or more example methods, the method 100 comprises obtaining S102 a waste gas.

The method 100 comprises breaking down S104 a waste gas, in a photochemical reactor via an ultraviolet source, into one or more primary gaseous by-products.

The method 100 comprises converting S106, in an absorption reactor via a liquid containing calcium ions, the one or more primary gaseous by-products into one or more secondary by-products.

In one or more example methods, breaking down the waste gas comprises breaking down S104A the waste gas into one or more by-products using ozone. In one or more example methods, breaking down the waste gas comprises breaking down S104A the waste gas into one or more by-products using an addition of oxygen breaking down into ozone in particular inside the photochemical reactor.

In one or more example methods, converting the one or more primary gaseous by-products comprises bubbling S106A the one or more primary gaseous by-products through the liquid containing calcium ions.

In one or more example methods, the method 100 comprises outputting S108 one or more secondary by-products.

### Examples

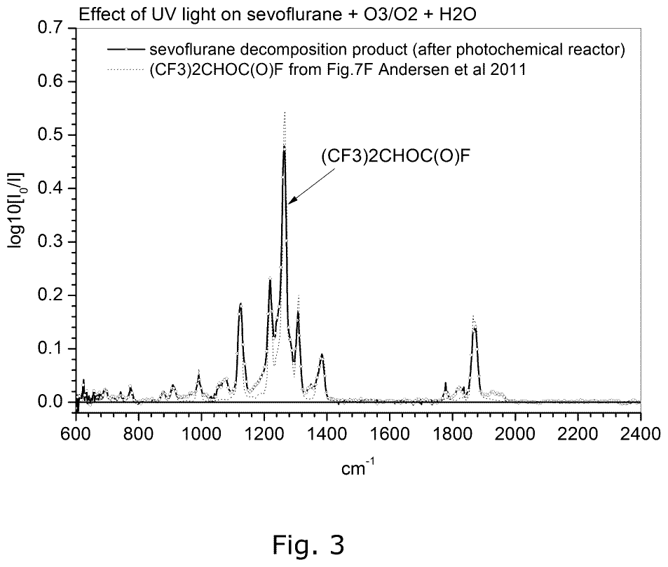

FIG. 3 shows an example of sevoflurane removal from a simulated exhaust from an anesthetic machine. FIG. 3 shows measured FTIR absorption spectra of photo-oxidation products of sevoflurane. The conditions of the experiment were as below:
Sevoflurane (410 ppm) in a dry air mixed with O₂/O₃ and H₂O(2 vol. %);
Total flow: 1.46 In/min
O₃ initial concentration after injection to the photochemical reactor: 0.82 vol. %

When the UV amalgam lamp (100 W) was activated the O₃ concentration dropped from 0.82 vol. % to 314 ppm. It means that many reactive species have been produced with use the UV 254 nm light. That caused 60% sevoflurane decomposition with (CF₃)₂CHOC(O)F, HF and COF₂ as the major by-products. A reference (CF₃)₂CHOC(O)F spectrum is shown by a dot line in FIG. 3 while a measured FTIR absorption spectrum after the photochemical reactor is shown by a solid line with opened circles.

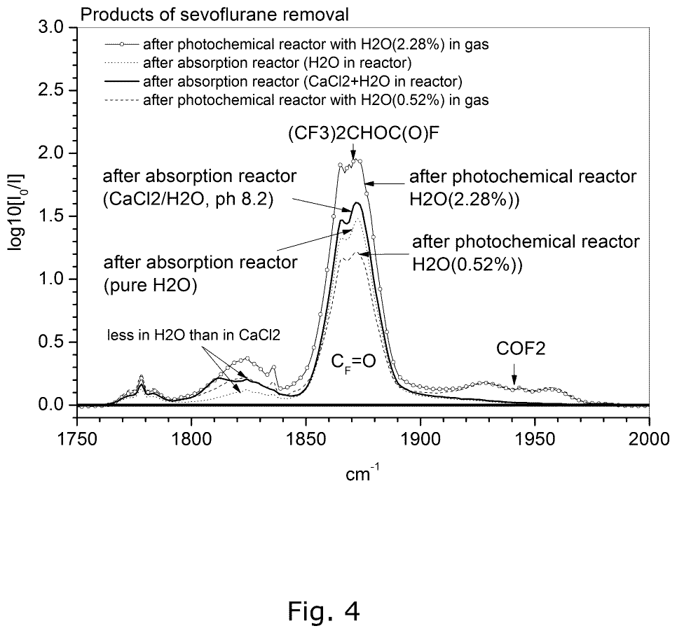

FIG. 4 below shows FTIR absorption measurements in gas phase (similar to the FIG. 3 above) after the photochemical reactor and the absorption reactor at higher gas flow rate (4.74 In/min).

At higher gas flowrate (4.74 In/min) sevoflurane reduction is lower (about 20% at sevoflurane concentration of 2.35%) compared to that at 1.47 In/min (about 50% at 410 ppm) because of shorter residence time in the photochemical reactor. This however can be mitigated with use several reactors connected in series as described above. One can see from FIG. 4 that water vapours influence (CF₃)₂CHOC(O)F by-product formation: higher water vapour concentrations work in favour of (CF₃)₂CHOC(O)F formation and therefore sevoflurane reduction (dash (H₂O at 0.52 vol. %) vs. solid with opened circles (H₂O at 2.28 vol. %) lines, after the photochemical reactor). The absorption reactor removes (CF₃)₂CHOC(O)F, COF₂ and HF from the gas (solid vs. dot (with CaCl₂) in H₂O solution with ph=8) and olive (pure H₂O), respectively). The COF₂ and HF are fully removed from the gas in the absorption reactor while (CF₃)₂CHOC(O)F is only partly removed. This can further be optimized by the residence time optimization and gas bubbling in the absorption reactor.

Whereas the above examples are based on simulated exhaust from an anesthetic machine, the actual waste gas from an anesthetic machine is primarily found in the exhale from a patient connected to the machine, and this exhale is usually not collected but released into the room, typically an operation theater. Considering the complexity and spatial limitation in most operation theaters, extra tubes, compressors and holding tanks for collecting the exhale from an anesthetized patient—while technically possible—is not currently in place. Therefore, the actual waste anesthetic gasses are to be found in very low concentrations in the ambient atmosphere of the operation theater.

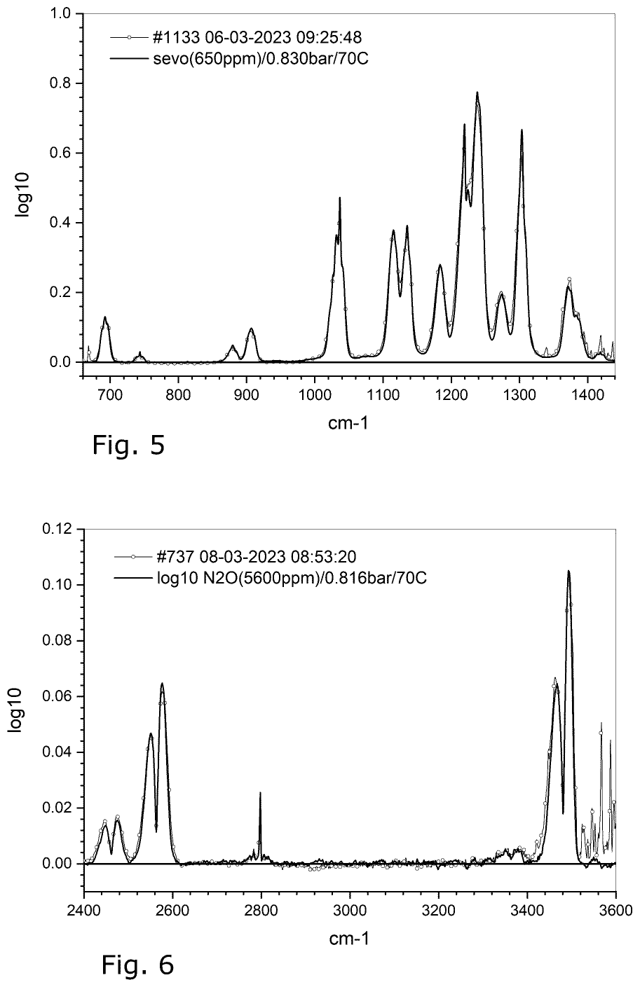

As part of a field test of the system of this disclosure two weeks of 24/7 measurements of common exhaust gas from surgery theatres have been performed at Rigshospitalet in Denmark. FIGS. 5 and 6 show FTIR absorption measurements of the combined exhaust gas from 32 surgery theatres. The graphs show the recorded absorption of sevoflurane (SEVO, FIGS. 5) and N₂O(FIG. 6) as well as fitted reference spectra. The measurements show that during working hours, sevoflurane (SEVO) and/or N₂O can be found in the common exhaust duct (i.e., a gas collected from all 32 surgery theatres in the hospital).

The highest SEVO and N₂O concentrations was 0.065 vol % and 0.56 vol % respectively, see FIGS. 5 and 6. If both SEVO and N₂O were present in the gas, their respective concentrations were typically lower (about two times lower for each gas component. There is no visible correlation between SEVO and N₂O concentrations and no other anesthetic gases were found.

Results of the SEVO reduction studies in the lab show that the SEVO removal efficiency increase at lower SEVO concentrations. In the laboratory studies the SEVO concentration was varying together with other parameters such as total gas flow rate, H₂O, O₃ concentrations, etc. Thus, for example, at a SEVO concentration of 0.56 vol % in the waste gas input to the photochemical reactor, the removal efficiency is 75%, while at a SEVO concentration of 0.11 vol % in the waste gas input to the photochemical reactor the removal efficiency is 90%. The SEVO removal efficiency was calculated based on FTIR absorption measurements in a special gas analysis system connected in series with the WAGER system. The measurements have been done first when the WAGER was in “OFF” state and then when the WAGER was activated (i.e. in “ON” state). The SEVO concentrations have been calculated with use of published SEVO reference IR absorption cross-section data and taking into account the pressure and temperature in the gas analysis system. Because SEVO concentration measured at Rigshospitalet is below the one used in the laboratory studies it is expected that at least the same (or even higher) SEVO reduction efficiency can be obtained in the real tests.

The use of the terms “first”, “second”, “third” and “fourth”, “primary”, “secondary”, “tertiary” etc. does not imply any particular order but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that FIGS. 1-2 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all the operations need to be performed. The example operations may be performed in any order and in any combination. It should be appreciated that these operations need not be performed in order presented.

Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method for destruction of waste anesthetic and/or refrigerant gas, the method comprising:
introducing waste anesthetic and/or refrigerant gas in a photochemical reactor;
breaking down the waste gas in the photochemical reactor into one or more primary gaseous by-products through irradiation with ultraviolet light and a gas-phase reaction with reactive radicals produced by irradiation with ultraviolet light;
conveying the primary gaseous by-products into an absorption reactor separate from the photochemical reactor;
converting the one or more primary gaseous by-products into one or more secondary by-products in the absorption reactor through reaction with a liquid containing calcium ions.

2. The method according to claim 1, wherein the waste anesthetic and/or refrigerant gas is a waste anesthetic gas comprising one or more of: nitrous oxide, isoflurane, desflurane and sevoflurane.

3. The method according to claim 1, wherein the waste anesthetic and/or refrigerant gas is a waste refrigerant gas comprising one or more of: an organohalogen gas, chloroflourocarbons (CFCs), R131a, R410a, 1,1,1,2 tetrafluoroethane, R-134a, Freon 134a, Forane 134a, Genetron 134a, Green Gas, Florasol 134a, Suva 134a, and HFC-134a.

4. The method according to claim 1, wherein producing reactive radicals comprise producing reactive radicals from the waste anesthetic and/or refrigerant gas.

5. The method according to claim 1, wherein producing reactive radicals comprise producing reactive radicals from O₂ (g) and H₂O(g) in the waste anesthetic and/or refrigerant gas.

6. The method according to claim 1, wherein producing reactive radicals comprise producing reactive radicals from one or more additives introduced into the photochemical reactor.

7. The method according to claim 6, wherein the one or more additives comprise one or more of: H₂O, NOₓ, NH₃, O₃ and O₂.

8. The method according to claim 6, wherein breaking down waste anesthetic and/or refrigerant gas comprises a gas-phase reaction with one or more additives introduced into the photochemical reactor.

9. The method according to claim 1, comprising maintaining an operation temperature inside the photochemical reactor between 0° C. and 90° C.

10. The method according to claim 1, wherein the one or more primary gaseous by-products includes hydrogen fluoride (HF) and/or hydrogen chloride (HCl).

11. The method according to claim 1, wherein the one or more secondary by-products comprises solid calcium fluoride and/or calcium chloride.

12. The method according to claim 1, comprising maintaining a pH of the liquid containing calcium ions in the absorption reactor in the range of 6 to 8.

13. The method according to claim 1, comprising sensing a pH value of the liquid in the absorption reactor; and, in response to the sensed pH value, controlling the breaking down of waste anesthetic and/or refrigerant gas by regulating one or more photochemical reactor operation parameters selected from:
flow rate of waste anesthetic gas into the photochemical reactor, flow rate of additives into the photochemical reactor, flow rate of the one or more primary gaseous by-products out of the photochemical reactor, flow rate of gas recirculated from the photochemical reactor and back into the photochemical reactor, intensity of the ultraviolet light, pH inside the photochemical reactor, temperature inside the photochemical reactor, pressure inside the photochemical reactor.

14. (canceled)

15. The method according to claim 1, wherein the photochemical reactor comprises two or more photochemical reactor chambers connected in series, each photochemical reactor chamber comprising an ultraviolet light source, and
wherein the method comprises conveying the waste anesthetic and/or refrigerant gas and produced primary gaseous by-products from a first photochemical reactor chamber in the series to a last photochemical reactor chamber in the series via any intermediate photochemical reactor chamber in the series.

16. The method according to claim 15, wherein the method comprises re-circulating at least part of the waste anesthetic and/or refrigerant gas and produced primary gaseous by-products from one photochemical reactor chamber in the series to a previous photochemical reactor chamber in the series.

17. A system for destruction of waste anesthetic and/or refrigerant gas, the system comprising:
a photochemical reactor comprising an ultraviolet source, wherein the photochemical reactor comprises inputs to receive a waste anesthetic and/or refrigerant gas and one or more gaseous additives and is configured to irradiate received gasses in the photochemical reactor with ultraviolet light to break down the waste anesthetic and/or refrigerant gas into one or more primary gaseous by-products in gas-phase reactions; and
an absorption reactor being separate from and connected in series with the photochemical reactor to receive the one or more primary gaseous by-products, the absorption reactor being configured to hold a liquid containing calcium ions and to mix the received one or more primary gaseous by-products with the liquid containing calcium ions to convert the one or more primary gaseous by-products into one or more secondary by-products.

18. The system according to claim 17, wherein the photochemical reactor comprises two or more photochemical reactor chambers connected in series, each photochemical reactor chamber comprising an ultraviolet light source, and wherein the two or more photochemical reactor chambers comprises a fluid connection to convey the waste anesthetic and/or refrigerant gas and produced primary gaseous by-products from a first photochemical reactor chamber in the series to a last photochemical reactor chamber in the series via any intermediate photochemical reactor chamber in the series.

19. The system according to claim 18, wherein the two or more photochemical reactor chambers comprises means to re-circulate at least part of the waste anesthetic and/or refrigerant gas and produced primary gaseous by-products from one photochemical reactor chamber in the series to a previous photochemical reactor chamber in the series.

20. The system according to claim 17, comprising:
a control unit for monitoring and controlling the destruction of waste anesthetic and/or refrigerant gas in the system;
a sensor for sensing a value related to a first operational parameter indicative of an efficiency of the breaking down of the waste anesthetic and/or refrigerant gas into one or more primary gaseous by-products; and
an actuator for regulating a second operational parameter impacting the breaking down of the waste anesthetic and/or refrigerant gas into one or more primary gaseous by-products;
wherein the control unit is configured to:
receive a sensed value from the sensor;
based on at least the sensed value, determine an adjustment of the second operational parameter; and
send a signal to the actuator to effectuate the determined adjustment of the second operational parameter.
